(19) United States
(12) Patent Application Publication
(10) Pub. No.: US 2024/0369801 A1
(43) Pub. Date: Nov. 7, 2024

(54) LENS ASSEMBLY

(71) Applicant: SAMSUNG ELECTRO-MECHANICS CO., LTD., Suwon-si (KR)

(72) Inventors: Yeo Ok JEON, Suwon-si (KR); Seok Hwan KIM, Suwon-si (KR)

(73) Assignee: SAMSUNG ELECTRO-MECHANICS CO., LTD., Suwon-si (KR)

(21) Appl. No.: 18/418,674

(22) Filed: Jan. 22, 2024

(30) Foreign Application Priority Data
May 4, 2023 (KR) 10-2023-0058519

(51) Int. Cl. G02B 7/02

(52) U.S. Cl. CPC G02B 7/022; G02B 7/021; G02B 7/026

(57) ABSTRACT

A lens assembly is provided. The lens assembly includes a plurality of lenses disposed along an optical axis, a spacer disposed between a rearmost lens, disposed in a rearmost position in an optical axis direction, among the plurality of lenses, and a lens disposed adjacent to the rearmost lens, and a lens barrel in which the plurality of lenses and the spacer are accommodated. The rearmost lens is configured to be screw-fastened to the lens barrel. The lens, disposed adjacent to the rearmost lens, or the spacer is screw-fastened to the lens barrel. The lens barrel has a through-hole which passes through a side surface of the lens barrel. A side surface of a component that is screw-fastened to the lens barrel, among the lens disposed to be adjacent to the rearmost lens and the spacer, opposes the through-hole.

### CROSS-REFERENCE TO RELATED APPLICATIONS

This application claims the benefit under 35 USC § 119 (a) of Korean Patent Application No. 10-2023-0058519 filed on May 4, 2023 in the Korean Intellectual Property Office, the entire disclosure of which is incorporated herein by reference for all purposes.

### BACKGROUND

### 1. Field

The following description relates to a lens assembly.

### 2. Description of Related Art

Camera modules have been implemented in portable electronic devices such as, but not limited to, smartphones, and camera module is provided with a lens assembly including a plurality of lenses.

Typically, after a plurality of lenses are assembled in a lens barrel, an adhesive may be used to fix positions of the plurality of lenses.

For example, an adhesive may be applied and cured between an internal surface of the lens barrel and a flange portion of a lens, disposed in a rearmost position in an optical axis direction, among the plurality of lenses.

However, there is a risk that a position of the lens may be unintentionally shifted during a process of curing the adhesive, resulting in a decrease in resolution.

The plurality of lenses may be screw-assembled to the lens barrel without using the adhesive.

However, there may be an issue that such a screw-fastened lens may loosen due to the effects of vibrations, shocks, and temperature changes applied to the lens assembly.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens assembly includes a plurality of lenses disposed along an optical axis; a spacer disposed between a rearmost lens, disposed in a rearmost position in an optical axis direction, among the plurality of lenses, and a lens disposed adjacent to the rearmost lens; and a lens barrel in which the plurality of lenses and the spacer are accommodated, wherein the rearmost lens is configured to be screw-fastened to the lens barrel, wherein either the lens which is disposed adjacent to the rearmost lens, or the spacer is screw-fastened to the lens barrel, wherein the lens barrel has a through-hole which passes through a side surface of the lens barrel, and wherein a side surface of a component that is screw-fastened to the lens barrel, among the lens disposed adjacent to the rearmost lens and the spacer, opposes the through-hole.

The through-hole may oppose a side surface of the spacer, and an assembly groove may be disposed in the side surface of the spacer.

A fastening groove may be disposed in each of a lower surface of the spacer and a lower surface of the rearmost lens.

A direction of a screw thread, formed on the side surface of the spacer, and a direction of a screw thread, formed on a side surface of the rearmost lens, may be a same direction.

The through-hole may oppose a side surface of the lens disposed adjacent to the rearmost lens, and an assembly groove may be disposed in the side surface of the lens disposed adjacent to the rearmost lens.

A fastening groove may be disposed in each of a lower surface of the rearmost lens and a lower surface of the lens disposed adjacent to the rearmost lens.

A direction of a screw thread, formed on a side surface of the rearmost lens, and a direction of a screw thread, formed on the side surface of the lens disposed adjacent to the rearmost lens, may be a same direction.

The through-hole may be configured to be sealed by a sealing member.

A first screw thread having a first pitch and a second screw thread having a second pitch may be disposed on an internal surface of the lens barrel, the second screw thread may be disposed in a further rear position than a position of the first screw thread in the optical axis direction, and the second pitch may be narrower than the first pitch.

The lens assembly may include a spring washer disposed to be in contact with each of two components screw-fastened to the lens barrel.

In a general aspect, a lens assembly includes a plurality of lenses disposed along an optical axis; a press-fit ring that supports a rearmost lens, disposed in a rearmost position in an optical axis direction, among the plurality of lenses; and a lens barrel that accommodates the plurality of lenses and the press-fit ring, wherein each of the rearmost lens and the press-fit ring is configured to be screw-fastened to the lens barrel, wherein a fastening groove is disposed in each of a lower surface of the rearmost lens and a lower surface of the press-fit ring, and wherein the fastening groove of the rearmost lens is disposed to be closer to the optical axis than an internal surface of the press-fit ring.

The lens barrel may have a through-hole, which passes through a side surface of the lens barrel, and a side surface of the rearmost lens opposes the through-hole.

An assembly groove may be disposed in the side surface of the rearmost lens.

The through-hole may be sealed by a sealing member.

A spring washer may be disposed to be in contact with each of the rearmost lens and the press-fit ring.

Other features and aspects will be apparent from the following detailed description, the drawings, and the claims.

### BRIEF DESCRIPTION OF DRAWINGS

FIG. 1 illustrates a schematic cross-sectional view of an example lens assembly, in accordance with one or more embodiments.

FIG. 2 illustrates an enlarged view of portion A of FIG. 1.

FIG. 3 and FIG. 4 are diagrams illustrating a process of assembling an example lens assembly, in accordance with one or more embodiments.

FIG. 5 is a diagram illustrating a shape of a seventh spacer of an example lens assembly, in accordance with one or more embodiments.

FIG. 6 is a diagram illustrating a screw thread, formed on an internal surface of a lens barrel, in accordance with one or more embodiments.

FIG. 7 is a schematic cross-sectional view of an example lens assembly, in accordance with one or more embodiments.

FIG. 8 illustrates an enlarged view of portion B of FIG. 7.

FIG. 9 is a schematic cross-sectional view of an example lens assembly, in accordance with one or more embodiments.

FIG. 10 illustrates an enlarged view of portion C of FIG. 9.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One or more examples may provide a lens assembly that firmly attaches a plurality of lenses to a lens barrel.

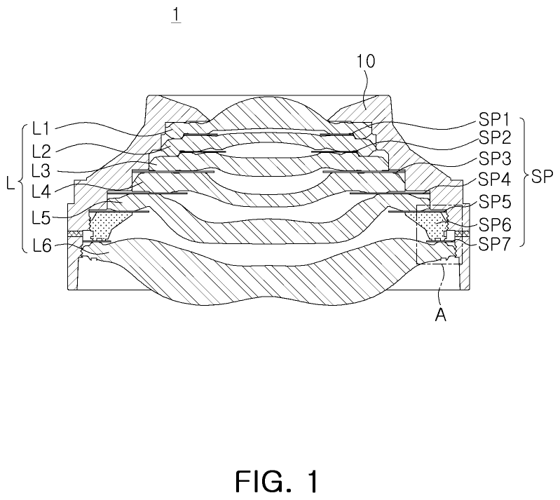

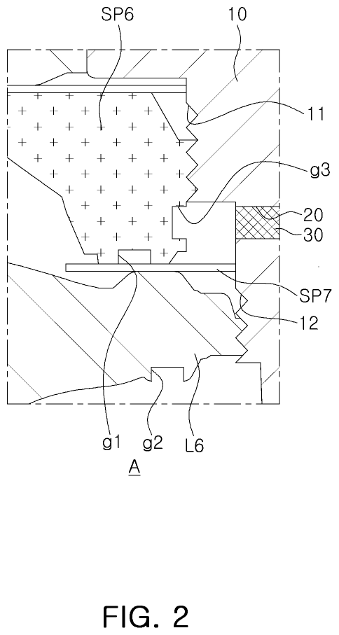

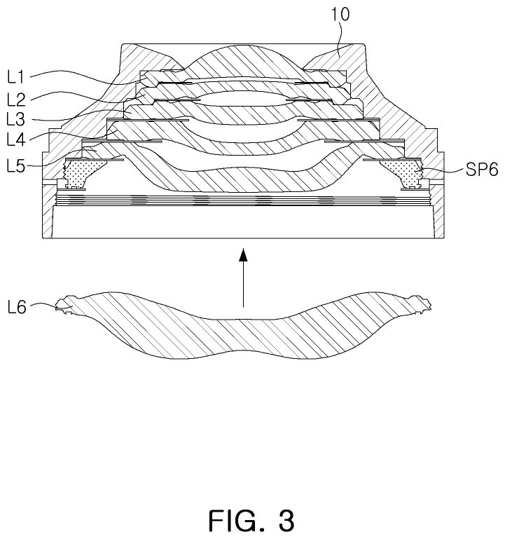

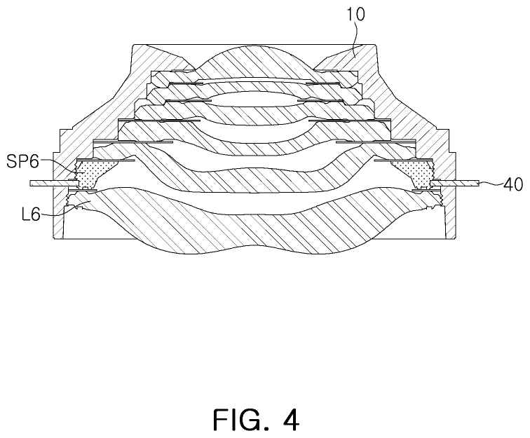

FIG. 1 illustrates a schematic cross-sectional view of an example lens assembly, in accordance with one or more embodiments, FIG. 2 illustrates an enlarged view of portion A of FIG. 1, and FIGS. 3 and 4 are diagrams illustrating a process of assembling an example lens assembly, in accordance with one or more embodiments.

Referring to FIGS. 1 to 4, a lens assembly 1, in accordance with one or more embodiments, may include a plurality of lenses L disposed along an optical axis. Additionally, the lens assembly 1 may further include a lens barrel 10 that accommodates the plurality of lenses L. In an example the plurality of lenses L may be spaced apart from each other by a preset distance along the optical axis.

The plurality of lenses L may include five or more lenses. For example, in the present example embodiment, the plurality of lenses L may include a first lens L1, a second lens L2, a third lens L3, a fourth lens L4, a fifth lens L5, and a sixth lens L6, disposed from an object side toward an image side along the optical axis.

The first lens L1 may refer to a lens (frontmost lens) closest to an object (or subject), and the sixth lens L6 may refer to a lens (rearmost lens) closest to an image sensor.

However, the spirit of the one or more examples is not limited by the number of lenses.

Each lens L may include an optical portion and a flange portion.

The optical portion may be a portion exhibiting optical performance of the lens L. For example, light reflected from an object (or subject) may be refracted while passing through the optical portion.

The flange portion may be configured to secure the lens L to another component, for example, the lens barrel 10, another lens, or a spacer. The flange portion may extend from a periphery of the optical portion, and may be formed integrally with the optical portion.

A spacer may be provided between adjacent lenses. At least a portion of the flange portion of each lens may be in contact with the spacer. The spacer may maintain a distance between lenses, and may block unnecessary light.

Each spacer may include a light absorption layer to block unnecessary light. In an example, the light absorption layer may be a black film or black iron oxide.

A plurality of spacers may include a first spacer SP1, a second spacer SP2, a third spacer SP3, a fourth spacer SP4, a fifth spacer SP5, a sixth spacer SP6, and a seventh spacer SP7, disposed from the object side toward the image sensor.

The first spacer SP1 may be disposed between the first lens L1 and the second lens L2, the second spacer SP2 may be disposed between the second lens L2 and the third lens L3, the third spacer SP3 may be disposed between the third lens L3 and the fourth lens L4, and the fourth spacer SP4 may be disposed between the fourth lens L4 and the fifth lens L5.

In addition, the fifth spacer SP5 to the seventh spacer SP7 may be sequentially disposed between the fifth lens L5 and the sixth lens L6.

At least one of a lens (for example the sixth lens L6), disposed to be closest to the image sensor, and a lens (for example, the fifth lens L5), disposed to be second closest to the image sensor, may be a lens having an inflection point.

Accordingly, a flange portion of the fifth lens L5 and a flange portion of the sixth lens L6 may be relatively far apart from each other in an optical axis direction, and accordingly, a relatively thick spacer may be disposed between the flange portion of the fifth lens L5 and the flange portion of the sixth lens L6.

For example, the sixth spacer SP6, among the plurality of spacers, may be formed to have a largest thickness. For example, a thickness of the sixth spacer SP6 in the optical axis direction may be greater than a thickness of each of the other spacers in the optical axis direction.

In the present example embodiment, the fifth spacer SP5 and the seventh spacer SP7 may be selectively adopted, as necessary.

Typically, after a plurality of lenses are attached to a lens barrel, an adhesive may be used to fix positions of the plurality of lenses.

For example, the adhesive may be applied and cured between a flange portion of a lens (for example, the sixth lens), closest to the image sensor, and an internal surface of the lens barrel.

However, there is a risk that a position of the lens may be unintentionally shifted during a process of curing the adhesive, resulting in a decrease in resolution.

Additionally, the plurality of lenses may be screw-assembled to the lens barrel without using the adhesive.

However, there is an issue that the screw-fastened lens may loosen due to the effects of vibrations, shocks, and temperature changes applied to the lens assembly.

The lens assembly, in accordance with one or more embodiments, may fix positions of the plurality of lenses with respect to the lens barrel regardless of whether the adhesive is used. Additionally, while a screw assembly method is used, the screw-fastened lens may be prevented from loosening.

Accordingly, two components, including a lens disposed to be closest to the image sensor, may each be screw-assembled to the lens barrel.

In an example, a lens, disposed to be closest to the image sensor, and a spacer, disposed in a front position of the lens, may each be screw-assembled to the lens barrel. Alternatively, the lens, disposed to be closest to the image sensor, and a lens, disposed to be second closest to the image sensor, may each be screw-assembled to the lens barrel. Alternatively, the lens, disposed to be closest to the image sensor, and a press-fit ring, disposed in a rear position of the lens, may each be screw-assembled to the lens barrel. Alternately, either the lens which is disposed adjacent to the rearmost lens, or the spacer is screw-fastened to the lens barrel.

Referring to FIGS. 1 and 2, the sixth lens L6, a lens disposed to be closest to the image sensor, among the plurality of lenses L, and the sixth spacer SP6 disposed in a front position of the sixth lens L6 may each be screw-assembled to the lens barrel.

A screw thread may be formed on each of a side surface of a flange portion of the sixth lens L6 and a side surface of the sixth spacer SP6, and a screw thread may also be formed on an internal surface of the lens barrel 10. The side surface of the flange portion of the sixth lens L6 may refer to a side surface of the sixth lens L6.

In an example, a direction of the screw thread, formed on the side surface of the flange portion of the sixth lens L6, and a direction of the screw thread, formed on the side surface of the sixth spacer SP6, may be the same.

The flange portion of the sixth lens L6 and the sixth spacer SP6 may each have a fastening groove that receives rotational force during screw assembly. In an example, a fastening groove g1 may be disposed in a lower surface of the sixth spacer SP6, and a fastening groove g2 may be disposed in a lower surface of the flange portion of the sixth lens L6.

The sixth lens L6 and the sixth spacer SP6 may each be screw-assembled to the lens barrel 10 by respectively fitting tools into the fastening groove g1 of the sixth spacer SP6 and the fastening groove g2 of the sixth lens L6 and turning the tools.

Referring to FIGS. 3 and 4, after the sixth spacer SP6 is screw-assembled to the lens barrel 10, the sixth lens L6 may also be screw-assembled to the lens barrel 10. In an example, the seventh spacer SP7, disposed between the sixth spacer SP6 and the sixth lens L6, may be an optional component.

In an example embodiment, the sixth spacer SP6 may be fastened with a first torque, and the sixth lens L6 may be fastened with a second torque in a state in which the sixth spacer SP6 is fixed. Here, the second torque may be greater than the first torque.

The sixth lens L6 may be fastened with the second torque, greater than the first torque, in a state in which the sixth spacer SP6 is fixed, such that a screw thread of the sixth spacer SP6 and a screw thread of the sixth lens L6 may each have strong tension with respect to a screw thread of the lens barrel 10, a counterpart.

Thus, frictional force between the screw thread of the sixth spacer SP6 and the screw thread of the lens barrel 10 and frictional force between the screw thread of the sixth lens L6 and the screw thread of the lens barrel 10 may be increased, and the sixth spacer SP6 and the sixth lens L6 may be prevented from loosening.

In an example in which the sixth spacer SP6 is not fixed when the sixth lens L6 is tightened with the second torque, it may be difficult to apply a desired tension to the sixth lens L6 and the sixth spacer SP6, and thus it may be difficult to expect an effect of preventing loosening.

Accordingly, a structure that fixes the sixth spacer SP6 may be desirous when the sixth lens L6 is tightened with the second torque.

In an example embodiment, the lens barrel 10 may have a through-hole 20 passing through a side surface thereof. The through-hole 20 may oppose the side surface of the sixth spacer SP6. For example, the side surface of the sixth spacer SP6 may be exposed to the outside of the lens barrel 10 through the through-hole 20.

In this example, an assembly groove g3 may be formed in the side surface of the sixth spacer SP6, and the assembly groove g3 and the through-hole 20 may be connected to each other.

Thus, after the sixth spacer SP6 is fastened to the lens barrel 10 with the first torque, a jig 40, (FIG. 4), may be inserted into the through-hole 20 of the lens barrel 10 to fit the jig 40 into the assembly groove g3 of the sixth spacer SP6, thereby fixing a position of the sixth spacer SP6.

In such a state, when the sixth lens L6 is fastened to the lens barrel 10 with the second torque, which is greater than the first torque, strong tension applied to each of the sixth spacer SP6 and the sixth lens L6 may allow the sixth spacer SP6 and the sixth lens L6 to be firmly attached to the lens barrel 10.

In the example embodiments of FIGS. 1 to 4, it is described that, in an example in which the sixth spacer SP6, a first component among two screw-assembled components is fixed, the sixth lens L6, a second component, may be tightened with a greater torque, but the assembly method is not limited thereto.

In an example, the sixth spacer SP6 and the sixth lens L6 may each be fastened with a preset torque, and the sixth spacer SP6 may be reversely rotated by a preset angle in a state in which the sixth lens L6 is fixed. In an example, reverse rotation may refer to rotation in a direction opposite to a direction in which the sixth spacer SP6 is fastened to the lens barrel 10.

The sixth spacer SP6 may be reversely rotated in an example in which the sixth lens L6 is fixed, such that a screw thread of the sixth spacer SP6 and a screw thread of the sixth lens L6 may each have strong tension with respect to a screw thread of the lens barrel 10, a counterpart.

Thus, frictional force between the screw thread of the sixth spacer SP6 and the screw thread of the lens barrel 10 and frictional force between the screw thread of the sixth lens L6 and the screw thread of the lens barrel 10 may be increased, and the sixth spacer SP6 and the sixth lens L6 may be prevented from loosening.

The fastening groove g2 of the sixth lens L6 may be used to fix the sixth lens L6, and the through-hole 20 of the lens barrel 10 and the assembly groove g3 of the sixth spacer SP6 may be used to reversely rotate the sixth spacer SP6.

When the sixth spacer SP6 and the sixth lens L6 are fastened to each other, a sealing member 30 may be inserted into the through-hole 20 of the lens barrel 10 to seal the through-hole 20. An adhesive or the like may be used as the sealing member 30.

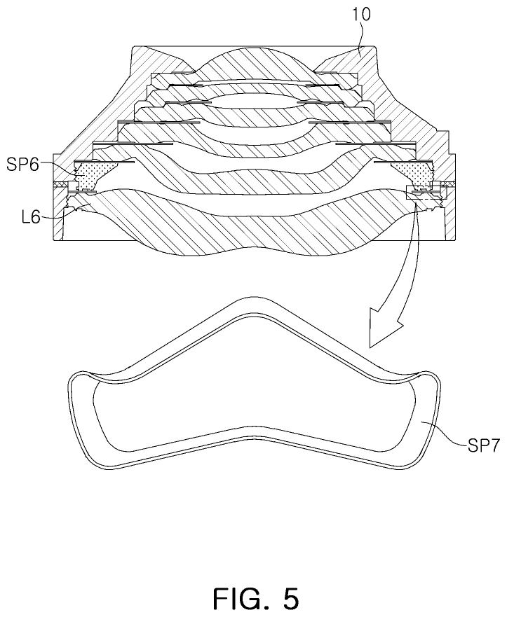

FIG. 5 is a diagram illustrating a shape of a seventh spacer of an example lens assembly, in accordance with one or more embodiments.

Referring to FIG. 5, a seventh spacer SP7 may be disposed between two screw-assembled components.

In an example, the seventh spacer SP7 may be disposed between the sixth spacer SP6 and the sixth lens L6, and may be in contact with each of the sixth spacer SP6 and the sixth lens L6.

In an example, the seventh spacer SP7 may have a ring shape, and a ring body may have one or more convex and concave shapes in an optical axis direction.

In an example, the seventh spacer SP7 may be a spring washer.

Accordingly, the seventh spacer SP7 may provide a force to push the sixth spacer SP6 and the sixth lens L6, and thus a frictional force between the sixth spacer SP6 and the lens barrel 10, and a frictional force between the sixth lens L6 and the lens barrel 10 may be increased.

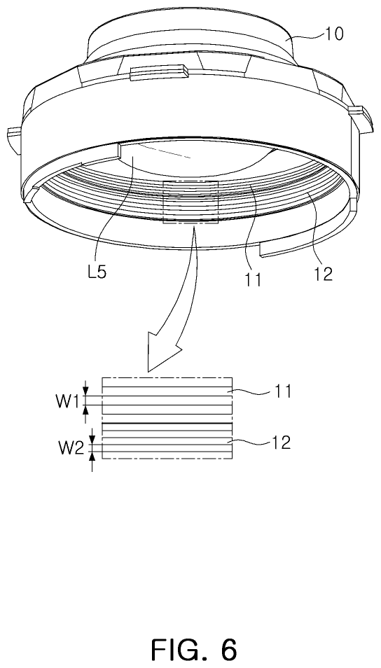

FIG. 6 is a diagram illustrating a screw thread, formed on an internal surface of a lens barrel, in accordance with one or more embodiments.

Referring to FIG. 6, a first screw thread 11 to which the sixth spacer SP6 is fastened and a second screw thread 12 to which the sixth lens L6 is fastened may be formed on an internal surface of the lens barrel 10.

A pitch w1 of the first screw thread 11 and a pitch w2 of the second screw thread 12 may be different from each other.

In an example, the pitch of the second screw thread 12, positioned to be closer to the image sensor, may be formed to be narrower than the pitch of the first screw thread 11.

Accordingly, stronger tension may be applied to the sixth lens L6, disposed to last among the plurality of lenses, thereby firmly fixing the plurality of lenses to the lens barrel 10.

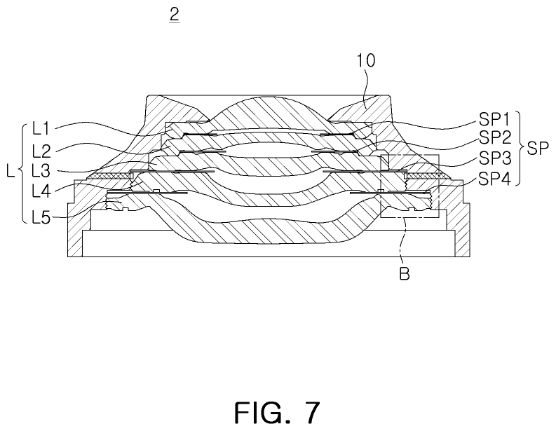

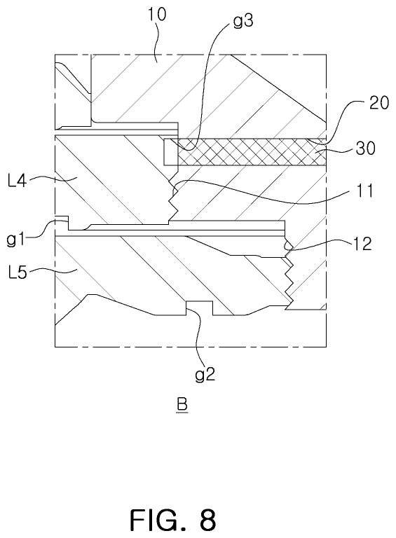

FIG. 7 illustrates a schematic cross-sectional view of an example lens assembly, in accordance with one or more embodiments, and FIG. 8 illustrates an enlarged view of portion B of FIG. 7.

Referring to FIGS. 7 and 8, a lens assembly 2, in accordance with one or more embodiments, may include a plurality of lenses L disposed along an optical axis. Additionally, the lens assembly 2 may further include a lens barrel 10 accommodating the plurality of lenses L. The plurality of lenses L may be spaced apart from each other by a preset distance along the optical axis.

The plurality of lenses L may include five or more lenses. In an example, in the present example embodiment, the plurality of lenses L may include a first lens L1, a second lens L2, a third lens L3, a fourth lens L4, and a fifth lens L5, disposed from an object side toward an image side along the optical axis.

The first lens L1 may refer to a lens closest to an object (or subject), and the fifth lens L5 may refer to a lens closest to an image sensor.

However, the one or more examples are not limited by the number of lenses.

A spacer may be provided between adjacent lenses. At least a portion of a flange portion of each lens may be in contact with the spacer. The spacer may maintain a distance between lenses, and may block unnecessary light.

Each spacer may include a light absorption layer to block unnecessary light. The light absorption layer may be a black film or black iron oxide.

A plurality of spacers may include a first spacer SP1, a second spacer SP2, a third spacer SP3, and a fourth spacer SP4, disposed from the object side toward the image sensor.

The first spacer SP1 may be disposed between the first lens L1 and the second lens L2, the second spacer SP2 may be disposed between the second lens L2 and the third lens L3, the third spacer SP3 may be disposed between the third lens L3 and the fourth lens L4, and the fourth spacer SP4 may be disposed between the fourth lens L4 and the fifth lens L5.

Referring to FIGS. 7 and 8, among the plurality of lenses, the fifth lens L5, a lens disposed to be closest to the image sensor, and the fourth lens L4, a lens disposed to be second closest to the image sensor, may each be screw-assembled to the lens barrel 10.

A screw thread may be formed on each of a side surface of a flange portion of the fourth lens L4 and a side surface of a flange portion of the fifth lens L5, and a screw thread may also be formed on an internal surface of the lens barrel 10.

In an example, a direction of the screw thread, formed on the side surface of the flange portion of the fourth lens L4, and a direction of the screw thread, formed on the side surface of the flange portion of the fifth lens L5, may be the same.

The flange portion of the fourth lens L4 and the flange portion of the fifth lens L5 may each have a fastening groove that receives a rotational force during screw assembly. For example, a fastening groove g1 may be disposed in a lower surface of the flange portion of the fourth lens L4, and a fastening groove g2 may be disposed in a lower surface of the flange portion of the fifth lens L5.

The fourth lens L4 and the fifth lens L5 may each be screw-assembled to the lens barrel 10 by respectively fitting tools into the fastening groove g1 of the fourth lens L4 and the fastening groove g2 of the fifth lens L5 and turning the tools.

The lens barrel 10 may have a through-hole 20 passing through a side surface thereof. The through-hole 20 may be connected to the side surface of the flange portion of the fourth lens L4. For example, the side surface of the flange portion of the fourth lens L4 may be exposed to the outside of the lens barrel 10 through the through-hole 20.

In this example, an assembly groove g3 may be formed in the side surface of the flange portion of the fourth lens L4, and the assembly groove g3 and the through-hole 20 may be connected to each other.

In an example embodiment, after the fourth lens L4 is fastened to the lens barrel 10 with a first torque, a jig may be inserted into the through-hole 20 of the lens barrel 10 to fit the jig into the assembly groove g3 of the fourth lens L4, thereby fixing a position of the fourth lens L4.

In such a state, when the fifth lens L5 is fastened to the lens barrel 10 with second torque, greater than the first torque, a strong tension may be applied to each of the fourth lens L4 and the fifth lens L5. Accordingly, the fourth lens L4 and the fifth lens L5 may be firmly attached to the lens barrel 10.

In another example embodiment, the fourth lens L4 and the fifth lens L5 may each be fastened with a preset torque, and the fourth lens L4 may be reversely rotated by a preset angle in a state in which the fifth lens L5 is fixed. In an example, reverse rotation may refer to a rotation in a direction opposite to a direction in which the fourth lens L4 is fastened to the lens barrel 10.

The fourth lens L4 may be reversely rotated in an example in which the fifth lens L5 is fixed, such that a screw thread of the fourth lens L4 and a screw thread of the fifth lens L5 may each have strong tension with respect to a screw thread of the lens barrel 10, a counterpart.

Thus, a frictional force between the screw thread of the fourth lens L4 and the screw thread of the lens barrel 10 and a frictional force between the screw thread of the fifth lens L5 and the screw thread of the lens barrel 10 may be increased, and the fourth lens L4 and the fifth lens L5 may be prevented from loosening.

In such a fastening method, the fastening groove g2 of the fifth lens L5 may be used to fix the fifth lens L5, and the through-hole 20 of the lens barrel 10 and the assembly groove g3 of the fourth lens L4 may be used to reversely rotate the fourth lens L4.

When the fourth lens L4 and the fifth lens L5 are fastened to each other, a sealing member 30 may be inserted into the through-hole 20 of the lens barrel 10 to seal the through-hole 20. An adhesive or the like may be used as the sealing member 30.

The fourth spacer SP4, disposed between the fourth lens L4 and the fifth lens L5, may be provided as a spring washer in the same manner the seventh spacer SP7 illustrated in FIG. 5.

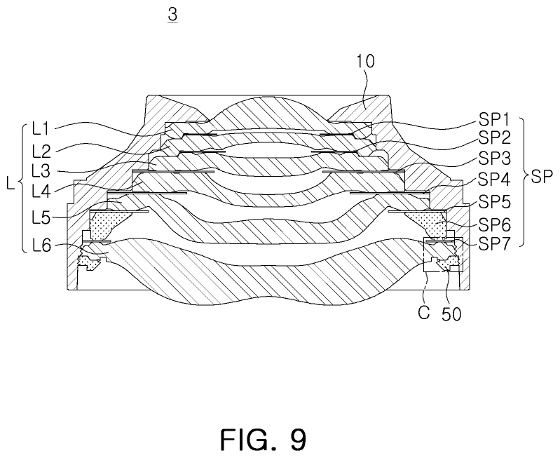

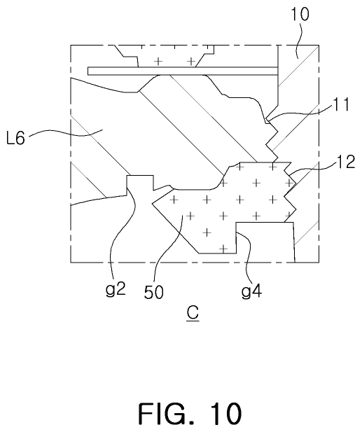

FIG. 9 illustrates a schematic cross-sectional view of an example lens assembly, in accordance with one or more embodiments. FIG. 10 illustrates an enlarged view of portion C of FIG. 9.

Referring to FIGS. 9 and 10, a lens assembly 3, in accordance with one or more embodiments, may include a plurality of lenses L disposed along an optical axis. Additionally, the lens assembly 3 may further include a lens barrel 10 that accommodates the plurality of lenses L. The plurality of lenses L may be spaced apart from each other by a preset distance along the optical axis.

The plurality of lenses L may include five or more lenses. In an example, in the present example embodiment, the plurality of lenses L may include a first lens L1, a second lens L2, a third lens L3, a fourth lens L4, a fifth lens L5, and a sixth lens L6, disposed from an object side toward an image side along the optical axis.

The first lens L1 may refer to a lens closest to an object (or subject), and the sixth lens L6 may refer to a lens closest to an image sensor.

However, the one or more examples are not limited by the number of lenses.

In the present example embodiment, a press-fit ring 50 may be disposed in a rear position of the sixth lens L6, a lens disposed to be closest to the image sensor.

The rear position of the sixth lens L6 may refer to a position closer to the image sensor than a flange portion of the sixth lens L6.

The press-fit ring 50 may support the sixth lens L6.

A spacer may be provided between adjacent lenses. At least a portion of a flange portion of each lens may be in contact with the spacer. The spacer may maintain a distance between lenses, and may block unnecessary light.

Each spacer may include a light absorption layer to block unnecessary light. The light absorption layer may be a black film or black iron oxide.

A plurality of spacers may include a first spacer SP1, a second spacer SP2, a third spacer SP3, a fourth spacer SP4, a fifth spacer SP5, a sixth spacer SP6, and a seventh spacer SP7, disposed from the object side toward the image sensor.

The first spacer SP1 may be disposed between the first lens L1 and the second lens L2, the second spacer SP2 may be disposed between the second lens L2 and the third lens L3, the third spacer SP3 may be disposed between the third lens L3 and the fourth lens L4, and the fourth spacer SP4 may be disposed between the fourth lens L4 and the fifth lens L5.

Additionally, the fifth spacer SP5 to the seventh spacer SP7 may be sequentially disposed between the fifth lens L5 and the sixth lens L6.

At least one of a lens (for example the sixth lens L6), disposed to be closest to the image sensor, and a lens (for example, the fifth lens L5), disposed to be second closest to the image sensor, may be a lens having an inflection point.

Accordingly, a flange portion of the fifth lens L5 and a flange portion of the sixth lens L6 may be relatively far apart from each other in an optical axis direction, and accordingly, a relatively thick spacer may be disposed between the flange portion of the fifth lens L5 and the flange portion of the sixth lens L6.

In an example, the sixth spacer SP6, among the plurality of spacers, may be formed to have a largest thickness. For example, a thickness of the sixth spacer SP6 in the optical axis direction may be greater than a thickness of each of the other spacers in the optical axis direction.

In the present example embodiment, the fifth spacer SP5 and the seventh spacer SP7 may be selectively adopted, as necessary.

Referring to FIGS. 9 and 10, the sixth lens L6, a lens disposed to be closest to the image sensor among the plurality of lenses, and the press-fit ring 50, disposed in a rear position of the sixth lens L6, may each be screw-assembled to the lens barrel 10.

A screw thread may be formed on each of a side surface of the flange portion of the sixth lens L6 and a side surface of the press-fit ring 50, and a screw thread may also be formed on an internal surface of the lens barrel 10.

In an example, a direction of the screw thread, formed on the side surface of the flange portion of the sixth lens L6, and a direction of the screw thread, formed on the side surface of the press-fit ring 50, may be the same.

The flange portion of the sixth lens L6 and the press-fit ring 50 may each have a fastening groove to receive a rotational force during screw assembly. For example, a fastening groove g2 may be disposed in a lower surface of the flange portion of the sixth lens L6, and a fastening groove g4 may be disposed in a lower surface of the press-fit ring 50.

The sixth lens L6 and the press-fit ring 50 may each be screw-assembled to the lens barrel 10 by respectively fitting tools into the fastening groove g2 of the sixth lens L6 and the fastening groove g4 of the press-fit ring 50 and turning the tools.

In an example embodiment, after the sixth lens L6 is fastened to the lens barrel 10 with first torque, a jig may be inserted into the fastening groove g2 of the sixth lens L6, thereby fixing a position of the sixth lens L6.

In such a state, when the press-fit ring 50 is fastened to the lens barrel 10 with a second torque, greater than the first torque, a strong tension may be applied to each of the sixth lens L6 and the press-fit ring 50. Accordingly, the sixth lens L6 and the press-fit ring 50 may be firmly attached to the lens barrel 10.

The position of the sixth lens L6 may need to be fixed through the jig while the press-fit ring 50 is fastened, and thus the fastening groove g2 of the sixth lens L6 may be disposed to be closer to the optical axis rather than an internal surface of the press-fit ring 50.

In another example embodiment, the sixth lens L6 and the press-fit ring 50 may each be fastened with a preset torque, and the sixth lens L6 may be reversely rotated by a preset angle in a state in which the press-fit ring 50 is fixed. In an example, reverse rotation may refer to rotation in a direction opposite to a direction in which the sixth lens L6 is fastened to the lens barrel 10.

The sixth lens L6 may be reversely rotated in an example in which the press-fit ring 50 is fixed, such that a screw thread of the sixth lens L6 and a screw thread of the press-fit ring 50 may each have strong tension with respect to a screw thread of the lens barrel 10, a counterpart.

Thus, a frictional force between the screw thread of the sixth lens L6 and the screw thread of the lens barrel 10, and a frictional force between the screw thread of the press-fit ring 50 and the screw thread of the lens barrel 10 may be increased, and the sixth lens L6 and the press-fit ring 50 may be prevented from loosening.

In such a fastening method, the fastening groove g4 of the press-fit ring 50 may be used to fix the press-fit ring 50, and the fastening groove g2 of the sixth lens L6 may be used to reversely rotate the sixth lens L6.

The sixth lens L6 may need to be reversely rotated through the jig in an example in which the press-fit ring 50 is fastened, and thus the fastening groove g2 of the sixth lens L6 may be disposed to be closer to the optical axis rather than the internal surface of the press-fit ring 50.

A spacer may be disposed between the sixth lens L6 and the press-fit ring 50. In this case, the spacer may be provided as a spring washer in the same manner the seventh spacer SP7 illustrated in FIG. 5.

In the example embodiments of FIGS. 9 and 10, a through-hole may not be disposed in the lens barrel 10. However, as illustrated in FIGS. 1 to 8, a through-hole may be disposed in the lens barrel 10.

In this example, the through-hole of the lens barrel 10 may be connected to the side surface of the flange portion of the sixth lens L6, and an assembly groove may be formed in the side surface of the flange portion of the sixth lens L6.

When the position of the sixth lens L6 is fixed or the sixth lens L6 is reversely rotated, the assembly groove of the sixth lens L6 and the through-hole of the lens barrel 10 may be used.

When the sixth lens L6 and the press-fit ring 50 are fastened to each other, a sealing member may be inserted into the through-hole of the lens barrel 10 to seal the through-hole. An adhesive or the like may be used as the sealing member.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly, comprising:
a plurality of lenses disposed along an optical axis;
a spacer disposed between a rearmost lens, disposed in a rearmost position in an optical axis direction, among the plurality of lenses, and a lens disposed adjacent to the rearmost lens; and
a lens barrel in which the plurality of lenses and the spacer are accommodated,
wherein the rearmost lens is configured to be screw-fastened to the lens barrel,
wherein either the lens which is disposed adjacent to the rearmost lens, or the spacer is screw-fastened to the lens barrel,
wherein the lens barrel has a through-hole which passes through a side surface of the lens barrel, and
wherein a side surface of a component that is screw-fastened to the lens barrel, among the lens disposed adjacent to the rearmost lens and the spacer, opposes the through-hole.

2. The lens assembly of claim 1, wherein:
the through-hole opposes a side surface of the spacer, and
an assembly groove is disposed in the side surface of the spacer.

3. The lens assembly of claim 2, wherein a fastening groove is disposed in each of a lower surface of the spacer and a lower surface of the rearmost lens.

4. The lens assembly of claim 2, wherein a direction of a screw thread, formed on the side surface of the spacer, and a direction of a screw thread, formed on a side surface of the rearmost lens, are a same direction.

5. The lens assembly of claim 1, wherein:
the through-hole opposes a side surface of the lens disposed adjacent to the rearmost lens, and
an assembly groove is disposed in the side surface of the lens disposed adjacent to the rearmost lens.

6. The lens assembly of claim 5, wherein a fastening groove is disposed in each of a lower surface of the rearmost lens and a lower surface of the lens disposed adjacent to the rearmost lens.

7. The lens assembly of claim 5, wherein a direction of a screw thread, formed on a side surface of the rearmost lens, and a direction of a screw thread, formed on the side surface of the lens disposed adjacent to the rearmost lens, are a same direction.

8. The lens assembly of claim 1, wherein the through-hole is configured to be sealed by a sealing member.

9. The lens assembly of claim 1, wherein:
a first screw thread having a first pitch and a second screw thread having a second pitch are disposed on an internal surface of the lens barrel,
the second screw thread is disposed in a further rear position than a position of the first screw thread in the optical axis direction, and
the second pitch is narrower than the first pitch.

10. The lens assembly of claim 1, further comprising:
a spring washer disposed to be in contact with each of two components screw-fastened to the lens barrel.

11. A lens assembly, comprising:
a plurality of lenses disposed along an optical axis;
a press-fit ring that supports a rearmost lens, disposed in a rearmost position in an optical axis direction, among the plurality of lenses; and
a lens barrel that accommodates the plurality of lenses and the press-fit ring,
wherein each of the rearmost lens and the press-fit ring is configured to be screw-fastened to the lens barrel,
wherein a fastening groove is disposed in each of a lower surface of the rearmost lens and a lower surface of the press-fit ring, and
wherein the fastening groove of the rearmost lens is disposed to be closer to the optical axis than an internal surface of the press-fit ring.

12. The lens assembly of claim 11, wherein:
the lens barrel has a through-hole, which passes through a side surface of the lens barrel, and
a side surface of the rearmost lens opposes the through-hole.

13. The lens assembly of claim 12, wherein an assembly groove is disposed in the side surface of the rearmost lens.

14. The lens assembly of claim 13, wherein the through-hole is sealed by a sealing member.

15. The lens assembly of claim 11, further comprising:
a spring washer disposed to be in contact with each of the rearmost lens and the press-fit ring.
